(19) United States
(12) Patent Application Publication
(10) Pub. No.: US 2021/0007036 A1
(43) Pub. Date: Jan. 7, 2021

(54) METHOD AND APPARATUS FOR PERFORMING HANDOVER IN MOBILE COMMUNICATION SYSTEM

(71) Applicant: Electronics and Telecommunications Research Institute, Daejeon (KR)

(72) Inventors: Hyun Seo PARK, Daejeon (KR); Yun Joo KIM, Seongnam-si Gyeonggi-do (KR); Eunkyung KIM, Daejeon (KR); Tae Joong KIM, Daejeon (KR); An Seok LEE, Daejeon (KR); Yu Ro LEE, Daejeon (KR); Sung Cheol CHANG, Daejeon (KR)

(73) Assignee: Electronics and Telecommunications Research Institute, Daejeon (KR)

(21) Appl. No.: 16/916,792

(22) Filed: Jun. 30, 2020

(30) Foreign Application Priority Data
Jul. 1, 2019 (KR) 10-2019-0078936
Jul. 4, 2019 (KR) 10-2019-0080804
Aug. 14, 2019 (KR) 10-2019-0099916
Jun. 25, 2020 (KR) 10-2020-0077587

(51) Int. Cl. H04W 36/30; H04W 24/10; H04W 48/20; H04W 76/19; H04W 24/08; H04B 17/336; H04W 76/27

(52) U.S. Cl. CPC H04W 36/305; H04W 24/10; H04W 48/20; H04W 76/27; H04W 24/08; H04B 17/336; H04W 76/19

(57) ABSTRACT

An operation method of a terminal in a communication system, according to the present disclosure, may comprise performing measurement on a source base station and neighbor base stations, and identifying a state of a radio link established between the terminal and the source base station; predicting a probability of a handover failure based on the state of the radio link and a measurement result according to the measurement; when it is predicted that the handover is to fail, identifying whether a handover command message is received from the source base station; and when the handover command message is not received, performing cell selection for radio connection re-establishment.

### CROSS-REFERENCE TO RELATED APPLICATIONS

This application claims priority to Korean Patent Applications No. 10-2019-0078936 filed on Jul. 1, 2019, No. 10-2019-0080804 filed on Jul. 4, 2019, No. 10-2019-0099916 filed on Aug. 14, 2019, and No. 10-2020-0077587 filed on Jun. 25, 2020 with the Korean Intellectual Property Office (KIPO), the entire contents of which are hereby incorporated by reference.

### BACKGROUND

### 1. Technical Field

The present disclosure relates generally to a method and an apparatus for performing handover in a mobile communication system, and more specifically, to a handover method for reducing a data interruption time due to an outage that may occur in a handover procedure in a mobile communication system, and an apparatus therefor.

### 2. Related Art

When a terminal passes through coverage of a source base station and moves to coverage of a target base station in a communication system, a handover may occur. The terminal may measure signal strengths of neighbor base stations, and transmit a measurement result. The source base station may instruct a target base station to prepare to perform a handover based on the measurement result. Thereafter, the source base station may instruct the terminal to perform the handover to the target base station. The terminal may receive a handover command message, and perform the handover. Specifically, the terminal may release a connection with the source base station, and attempt to connect to the target base station.

On the other hand, when a state of a radio link established between the source base station and the terminal is not good, the handover procedure may not be performed smoothly. For example, when the state of the radio link between the terminal and the source base station is not good, an outage time during which the terminal cannot receive data may become long. If the outage time in which the data cannot be received becomes long, communication quality may deteriorate. Thereafter, the terminal may identify that a failure of the radio link occurs and perform a recovery procedure. The terminal may select a target base station through the recovery procedure. In this process, an interruption time during which data cannot be transmitted may occur.

### SUMMARY

Accordingly, exemplary embodiments of the present disclosure are directed to providing handover methods for reducing a data interruption time due to an outage that may occur in a handover procedure in a mobile communication system, and apparatuses therefor.

According to an exemplary embodiment of the present disclosure, an operation method of a terminal in a communication system may comprise performing measurement on a source base station and neighbor base stations, and identifying a state of a radio link established between the terminal and the source base station; predicting a probability of a handover failure based on the state of the radio link and a measurement result according to the measurement; when it is predicted that the handover is to fail, identifying whether a handover command message is received from the source base station; and when the handover command message is not received, performing cell selection for radio connection re-establishment.

Here, the state of the radio link may be identified by the terminal through radio link monitoring (RLM).

Here, when out-of-sync messages are continuously received from a physical layer of the terminal, the terminal may predict that the handover is to fail.

Here, the out-of-sync message may be received from the physical layer of the terminal, when a value of a signal-to-interference-and-noise ratio (SINR) of a signal received from the source base station is less than a predetermined threshold.

Here, when a value of one of a reference signal received power (RSRP) and a reference signal received quality (RSRQ) of a signal received from the source base station is less than a predetermined threshold, the terminal may predict that the handover is to fail.

Here, the performing of the cell selection may comprise determining validity of the measurement result; and when the measurement result is determined to be valid, performing the cell selection for the radio connection re-establishment based on the measurement result, wherein the measurement is performed before performing the cell selection for the radio connection re-establishment.

Here, the measurement result may be determined to be valid, when a difference value between a time of performing the measurement and a time of performing the cell selection for the radio connection re-establishment is less than a time value indicated by valid time information received from the source base station.

Here, the operation method may further comprise, when the measurement result is determined to be not valid, performing a cell selection procedure utilizing stored information.

Here, the operation method may further comprise, when a cell for the radio connection re-establishment is not selected based on the cell selection procedure utilizing stored information, performing an initial cell selection procedure.

Here, the operation method may further comprise performing a radio resource control (RRC) connection re-establishment procedure with a target base station selected through the cell selection.

According to another exemplary embodiment of the present disclosure, a terminal in a communication system may comprise a processor; a memory electronically communicating with the processor; and instructions stored in the memory, wherein when executed by the processor, the instructions cause the terminal to: perform measurement on a source base station and neighbor base stations, and identify a state of a radio link established between the terminal and the source base station; predict a probability of a handover failure based on the state of the radio link and a measurement result according to the measurement; when it is predicted that the handover is to fail, identify whether a handover command message is received from the source base station; and when the handover command message is not received, perform cell selection for radio connection re-establishment.

Here, the state of the radio link may be identified by the terminal through radio link monitoring (RLM).

Here, when out-of-sync messages are continuously received from a physical layer of the terminal, the terminal may predict that the handover is to fail.

Here, the out-of-sync message may be received from the physical layer of the terminal, when a value of a signal-to-interference-and-noise ratio (SINR) of a signal received from the source base station is less than a predetermined threshold.

Here, when a value of one of a reference signal received power (RSRP) and a reference signal received quality (RSRQ) of a signal received from the source base station is less than a predetermined threshold, the terminal may predict that the handover is to fail.

Here, the performing of the cell selection may comprise determining validity of the measurement result; and when the measurement result is determined to be valid, performing the cell selection for the radio connection re-establishment based on the measurement result, wherein the measurement is performed before performing the cell selection for the radio connection re-establishment.

Here, the measurement result may be determined to be valid, when a difference value between a time of performing the measurement and a time of performing the cell selection for the radio connection re-establishment is less than a time value indicated by valid time information received from the source base station.

Here, the instructions may further cause the terminal to, when the measurement result is determined to be not valid, perform a cell selection procedure utilizing stored information.

According to the exemplary embodiments of the present disclosure, the terminal can minimize a data interruption time due to an outage that may occur during execution of a handover by performing a recovery procedure in advance before a failure of a radio link between the source base station and the terminal occurs. Therefore, the terminal can perform a handover with reduced latency and improved performance.

In addition, the terminal can have a high data transmission efficiency and can perform the handover with a minimum service interruption time. Further, the terminal can improve the communication quality by minimizing the data interruption time due to the outage that may occur during execution of the handover.

### BRIEF DESCRIPTION OF DRAWINGS

FIG. 1 is a conceptual diagram illustrating a communication network according to a first exemplary embodiment of the present disclosure.

FIG. 2 is a block diagram illustrating a communication node according to a first exemplary embodiment of the present disclosure.

FIG. 3 is a state transition diagram of a terminal in a handover procedure.

FIG. 4 is a sequence chart illustrating a first exemplary embodiment of a handover procedure.

FIG. 5A is a sequence chart illustrating a second exemplary embodiment of a handover procedure.

FIG. 5B is a timing diagram illustrating a recovery operation according to a handover failure in a handover procedure.

FIG. 6 is a sequence chart illustrating a first exemplary embodiment of an RRC connection re-establishment procedure in a handover procedure.

FIG. 7 is a sequence chart illustrating a second exemplary embodiment of an RRC connection reconfiguration procedure in a handover procedure.

FIG. 8 is a sequence chart illustrating a first exemplary embodiment of a cell selection procedure.

FIG. 9 is a graph illustrating a data transmission gain obtained through the second exemplary embodiment of the RRC connection re-establishment procedure of FIG. 7.

FIG. 10 is a sequence chart illustrating a third exemplary embodiment of a handover procedure.

FIG. 11 is a sequence chart illustrating a second exemplary embodiment of a cell selection procedure.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

Throughout the specification, a network may include, for example, a wireless Internet such as wireless fidelity (WiFi), a mobile Internet such as a wireless broadband Internet (WiBro) or a world interoperability for microwave access (WiMax), a 2G mobile communication network such as a global system for mobile communication (GSM) or a code division multiple access (CDMA), a 3G mobile communication network such as a wideband code division multiple access (WCDMA) or a CDMA2000, a 3.5G mobile communication network such as a high speed downlink packet access (HSDPA) or a high speed uplink packet access (HSUPA), a 4G mobile communication network such as a long term evolution (LTE) network or an LTE-Advanced network, a 5G mobile communication network, or the like.

Throughout the specification, a terminal may refer to a mobile station, a mobile terminal, a subscriber station, a portable subscriber station, a user equipment, an access terminal, or the like, or may include all or a part of functions of the terminal, the mobile station, the mobile terminal, the subscriber station, the portable subscriber station, the user equipment, the access terminal, or the like.

Here, a desktop computer, a laptop computer, a tablet PC, a wireless phone, a mobile phone, a smart phone, a smart watch, a smart glass, an e-book reader, a portable multimedia player (PMP), a portable gaming machine, a navigation device, a digital camera, a digital multimedia broadcasting (DMB) player, a digital audio recorder, a digital audio player, a digital picture recorder, a digital picture player, a digital video recorder, a digital video player, and/or the like, which has communication capability, may be used as the terminal.

Throughout the specification, a base station may refer to an access point, a radio access station, a Node B, an evolved Node B, a base transceiver station, a mobile multi-hop relay (MMR)-BS, or the like, or may include all or a part of functions such as the base station, the access point, the radio access station, the Node B, the evolved Node B, the base transceiver station, the MMR-BS, or the like.

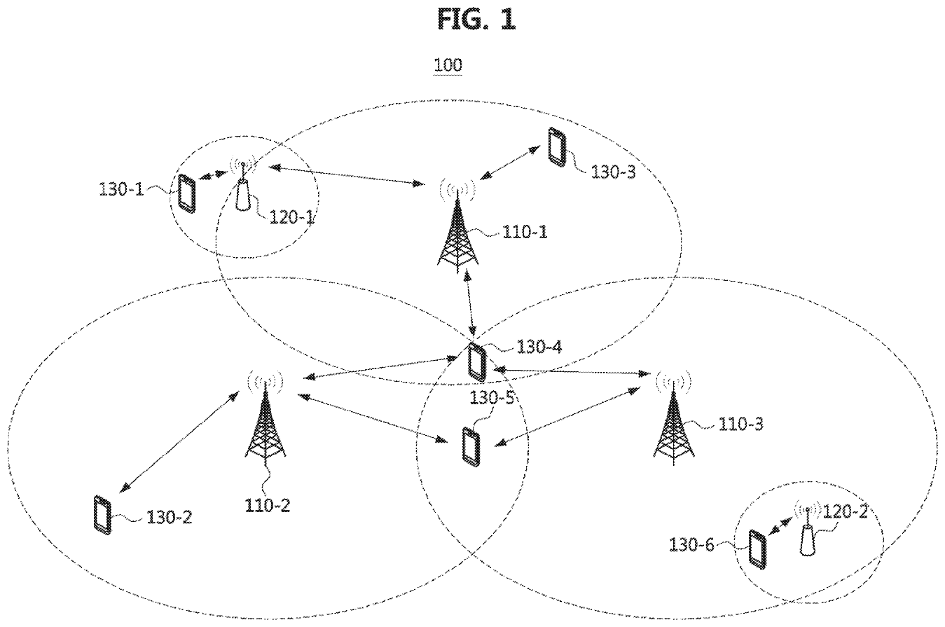

FIG. 1 is a conceptual diagram illustrating a communication network according to a first exemplary embodiment of the present disclosure. Referring to FIG. 1, a communication network 100 may comprise a plurality of communication nodes 110-1, 110-2, 110-3, 120-1, 120-2, 130-1, 130-2, 130-3, 130-4, 130-5, and 130-6. Each of the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a space division multiple access (SDMA) based communication protocol, and/or the like. Each of the plurality of communication nodes may have the following structure.

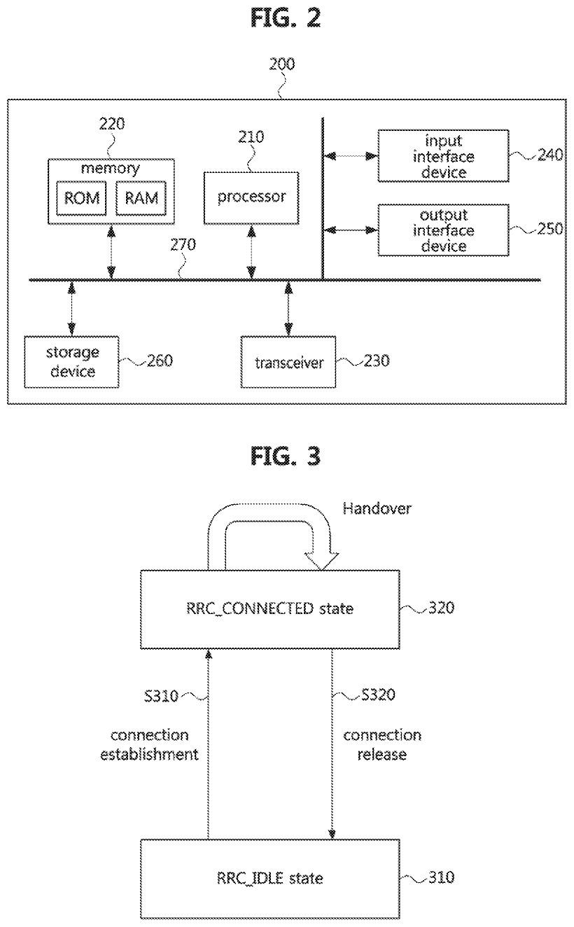

FIG. 2 is a block diagram illustrating a communication node according to a first exemplary embodiment of the present disclosure. Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270. However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

FIG. 3 is a state transition diagram of a terminal in a handover procedure.

Referring to FIG. 3, when an RRC connection with a base station is successfully established through an RRC connection establishment procedure (S310) in an RRC idle state (i.e., RRC IDLE state, 310), the terminal may transition to an RRC connected state (i.e., RRC CONNECTED state, 320).

The terminal in the RRC connected state 320 may transition back to the RRC idle state 310 when the RRC connection with the base station is released through an RRC connection release procedure (S320). In addition, when the terminal in the RRC connected state 320 performs a handover to change the serving base station (or cell), and re-establishes a connection with the changed serving base station (i.e., target base station), the terminal may maintain the RRC connected state with the changed serving base station.

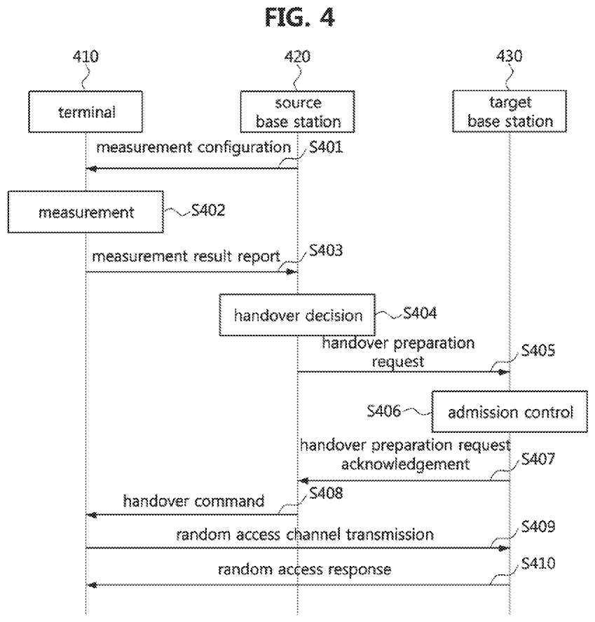

FIG. 4 is a sequence chart illustrating a first exemplary embodiment of a handover procedure.

The handover procedure illustrated in FIG. 4 is briefly reconstructed based on steps necessary to describe exemplary embodiments of the present disclosure, and detailed steps or subsequent steps may be omitted.

Referring to FIG. 4, a source base station 420 (or source cell) may perform measurement configuration so that a terminal 410 performs measurement on neighbor base stations including a target base station 430 (or target cell) (S401). The terminal 410 may measure signal strengths of neighbor base stations (S402), and report a measurement result (i.e., measurement report) to the source base station 420 (S403). In this case, the reported measurement result may include cell-level measurement results of the neighbor base stations.

The source base station 420 may determine a handover to the target base station 430 based on the received measurement result (S404), and transmit a handover preparation request message to the target base station 430 to instruct the target base station to prepare for the handover (S405). The target base station 430 may determine whether to approve the handover of the terminal 410 through admission control (S406). When it is determined that the target base station 430 approves the handover of the terminal 410, the target base station may transmit a handover preparation request acknowledgment message to the source base station 420 (S407).

The source base station 420 may transmit a handover command message to the terminal 410 (S408). Here, the handover command message may be transmitted as an RRC signaling message (e.g., ‘RRCConnectionReconfiguration’ message). The handover command message may include information on resources to be used by the terminal 410 in a random access (RA) procedure for the target base station 430.

Upon receiving the handover command message, the terminal 410 may perform the handover. The terminal 410 may release the connection with the source base station 420, and attempt to access the target base station 430. The terminal 410 may attempt a random access (RA) based on the information on the resources to be used in the random access procedure provided by the target base station 430, which is included in the handover command message (S409). That is, the terminal 410 may transmit a random access channel (RACH). The target base station 430 may transmit a random access response (RAR) to the terminal 410 in response to the RACH (S410).

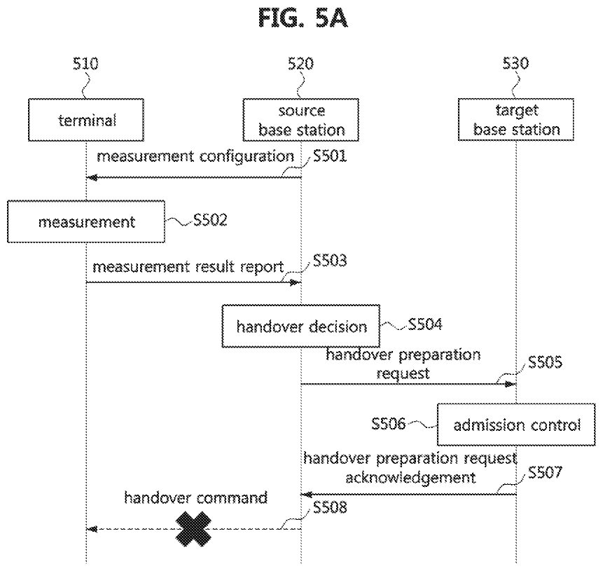

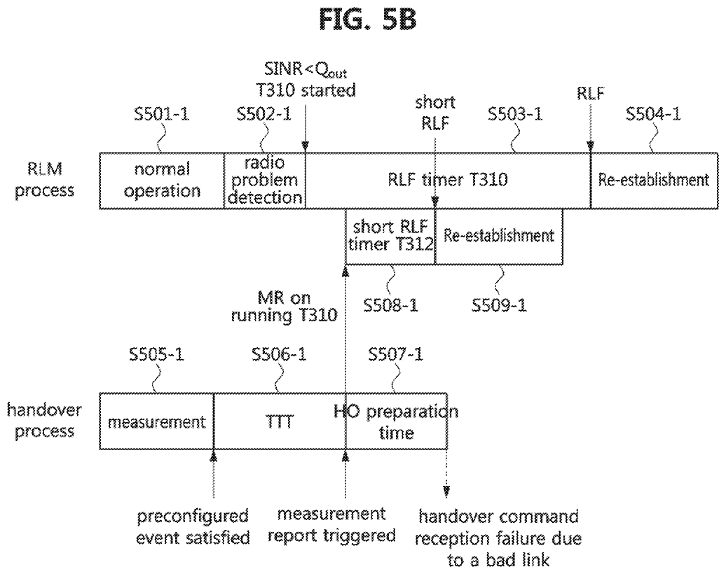

FIG. 5A is a sequence chart illustrating a second exemplary embodiment of a handover procedure.

Referring to FIG. 5A, a source base station 520 may perform measurement configuration so that a terminal 510 performs measurement on neighbor base stations including a target base station 530 (S501). The terminal 510 may measure signal strengths of neighbor base stations (S502), and report a measurement result to the source base station 520 (S503). In this case, the reported measurement result may include cell-level measurement results of the neighbor base stations.

The source base station 520 may determine a handover to the target base station 530 based on the received measurement result (S504). The source base station 520 may instruct the target base station to prepare for the handover by transmitting a handover preparation request message to the target base station 430 (S505). On the other hand, the target base station 530 may determine whether to approve the handover of the terminal 510 through admission control (S506). When it is determined that the target base station 530 approves the handover of the terminal 510, the target base station may transmit a handover preparation request acknowledgment message to the source base station 520 (S507).

The source base station 520 may transmit a handover command message to the terminal 510 (S508). On the other hand, when a state of a radio link established between the source base station 520 and the terminal 510 is not good, the handover command message transmitted by the source base station 520 to the terminal 510 may not be transferred to the terminal 510 in real time. That is, the terminal 510 may not receive the handover command message from the source base station 520.

In this case, the terminal 510 may continue to maintain the connection with the source base station 520 until a radio link failure (RLF) is detected. Even though the state of the radio link between the terminal 510 and the source base station 520 is not good, if the terminal 510 continues to maintain the connection with the source base station 520, an outage time during which data cannot be received may become long. When the outage time during which data cannot be received becomes long, a communication quality may deteriorate.

FIG. 5B is a timing diagram illustrating a recovery operation according to a handover failure in a handover procedure.

Referring to FIG. 5B, the radio link between the terminal and the base station may be normally connected (S501-1). That is, the terminal may be in a normal operation state. In this case, the physical layer of the terminal may continuously measure a wideband SINR of the serving cell to which the terminal is connected. The measured average wideband SINR value may be compared to two thresholds. Here, the two thresholds may be Qₒᵤₜ for determining out-of-sync and Qᵢₙ for determining in-sync. These may correspond to physical downlink control channel (PDCCH) block error rates (BLERs) of 10% and 2%, respectively.

In order to eliminate a fading effect, Qₒᵤₜ and Qᵢₙ may be usually monitored as averages over a specific time window. When the corresponding wideband SINR is lower than the threshold Qₒᵤₜ, there may be a problem in the radio link. In this case, the physical layer may report an out-of-sync indication to the RRC layer of the terminal (S502-2).

When the RRC layer continuously receives the out-of-sync indications predefined N310 times, a timer T310 may be started (S503-1). When the in-sync indications are continuously reported predefined N311 times before the timer T310 expires, the timer T310 may be stopped and the normal operation state (S501-1) may continue. Otherwise, when the timer T310 expires, the terminal may declare an RLF, and an RRC connection re-establishment procedure may be performed as an RLF recovery procedure (S504-1). Normally, a default value 1 may be used for N310 and N311, and a default value 1000 ms may be used for T310.

Setting of the value of T310 may influence the determination of the RLF. When the T310 is set to be very short, the RLF may be frequently declared even for a short period of fading or measurement error, and thus the RLF recovery may not be automatically performed. In addition, the RLF recovery procedure through the RRC connection re-establishment procedure may be unnecessarily performed, which may cause a problem of a long data interruption time.

Conversely, when the value of T310 is set to be very long, the terminal may continue to maintain the connection with the serving cell in a situation where the RLF recovery is not automatically performed, such as when a handover failure occurs, so that the required RLF recovery procedure may not be performed. That is, the terminal may continue to maintain the radio link connection with the serving cell, so that the outage may last for a long time, and a problem in which the data interruption time increases may occur.

In order to solve such the problem, the RLF recovery procedure may be quickly performed on the RLF that may occur during the handover of the terminal. That is, the RLF recovery procedure may be performed quickly by disconnecting the radio link with the serving cell. In this case, the data interruption time that may occur due to the outage may be reduced.

When the radio link between the terminal and the base station is normally connected (i.e., when the terminal is in the normal operation state (S501)), the handover process may operate according to the configuration of the base station, and the handover process may be performed independently of the above-described radio link monitoring process.

Accordingly, the radio link monitoring process may not know the state of the handover process. The handover process may measure signal strengths of the source cell and the neighbor cells according to the configuration of the base station (S505-1). Normally, when a preconfigured event (i.e., entering condition) is satisfied and this state is maintained for a preconfigured time-to-trigger (TTT) time (S506-1), the terminal may report measurement information to the source base station.

During the handover preparation time, the source base station may determine the handover, and request the handover of the terminal to the target base station. When the target base station approves the handover, the target base station may transmit to the source base station a response message including a handover command message to be transmitted to the terminal (S507-1).

During the handover preparation time, the terminal may move closer to the target cell, and the radio link state with the source cell may deteriorate. As a result, the handover command message may not be received from the source cell due to severe interference from the target cell. In this case, an RLF may be declared, and there may be a problem that a time during which the outage occurs while connecting to the source cell is longer before the RLF recovery procedure is performed.

Normally, during the handover, the T310 timer may expire when one or more neighbor cells are significantly better than the source cell. Accordingly, if the terminal does not continuously maintain the connection with the source cell having the poor radio link state, and performs a cell change to a neighbor cell having the good radio link state faster, the data interruption time due to the outage may be significantly reduced.

For this, a short RLF timer T312 may be introduced to quickly recover the RLF that may occur during the handover. The timer T312 may allow the RLF occurring in the handover situation to be differentiated from an RLF occurring due to a coverage hole. The value of T312 may be set to allow the former to be optimized, and the value of T310 may be set to allow the latter to be optimized.

When the measurement report is triggered to prepare for the handover while the T310 is running, the terminal may start the timer T312 (S508-1). When any one of the timers T310 and T312 expires, the terminal may declare an RLF and perform an RLF recovery procedure (S509-1). In this case, the data interruption time due to the outage that may occur in the process of performing handover may be reduced, and the user throughput may be increased.

However, the timer T312 may have two disadvantages. First, the timer T312 may not guarantee a success of the RLF recovery procedure. Since the neighbor cell is in a better state than the source cell at the time when the timer T312 is started, the probability of success of the RLF recovery procedure may increase. However, if such the state is not maintained at the time when the timer T312 expires, or if another neighbor cell is in a better state, the RLF recovery procedure may fail.

Second, the timer T312 may not be able to completely remove the outage. Since the terminal runs the timer T312 only while the T310 is running, it may not be able to remove the already generated outage before the T312 is started. In addition, since the out-of-sync indication may be reported when the average wideband SINR is lower than Qₒᵤₜ for a certain period of time, and the T310 is started to eliminate the fading effect, the outage may not be completely removed. Therefore, when the probability of occurrence of RLF is high, a method of declaring the RLF faster and allowing the RLF recovery procedure to be performed faster may be required regardless of the timer T310.

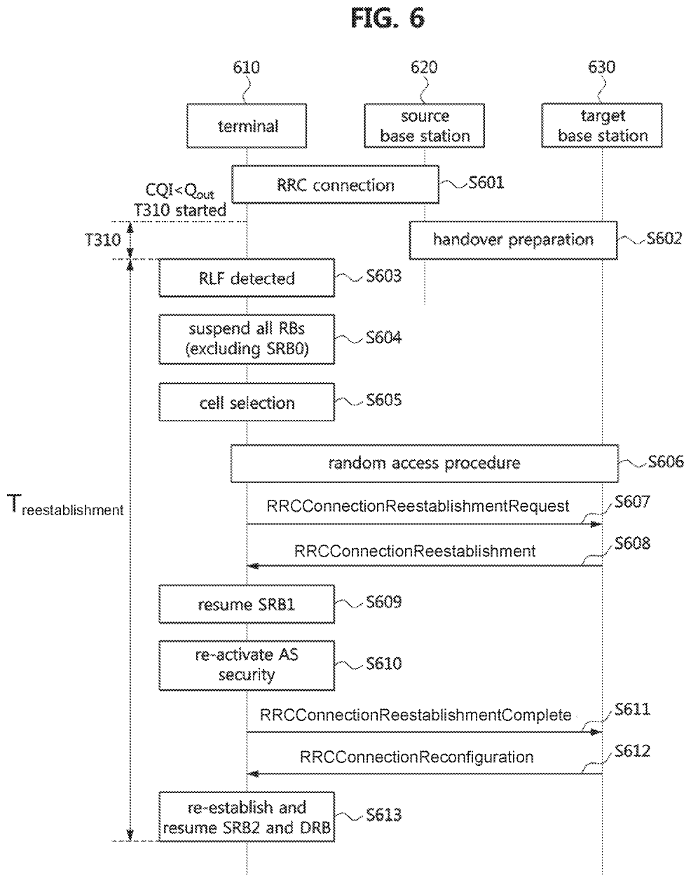

FIG. 6 is a sequence chart illustrating a first exemplary embodiment of an RRC connection re-establishment procedure in a handover procedure.

Referring to FIG. 6, when a state of a radio link established between a source base station 620 and a terminal 610 is not good, the terminal 610 may not receive a handover command message from the source base station 620, and may continue to maintain a connection with the source base station 620 until an RLF is detected (S601). In order to overcome this, the terminal 610 may perform an RRC connection re-establishment procedure.

For example, when a BER of physical downlink control channel (PDCCH) exceeds a predetermined threshold, the terminal 610 may determine that an out-of-sync has occurred. At this time, the terminal 610 may start a timer T310 which is an RLF timer. Meanwhile, the source base station 620 and a target base station 630 may prepare for a handover from the source base station 620 to the target base station 630 (S602). Through the handover preparation, if an RLF occurs while the terminal 610 performs the handover to the target base station 630, an RLF recovery procedure may be performed smoothly.

Meanwhile, if the PDCCH BLER does not satisfy a predetermined reference value until the T310 timer expires, the terminal 610 may determine that an RLF occurs (S603). When the RLF is detected, the terminal 610 may suspend all radio bearers (RBs) excluding a signaling radio bearer 0 (SRB0) (S604). An SRB may be used for transferring an RRC signaling message and a non-access stratum (NAS) message. The RRC message may be used for signaling between the terminal 610 and the base station, and the NAS message may be used for signaling between the terminal 610 and a mobility management entity (MME).

The terminal 610 that has suspended all radio bearers (RBs) excluding the SRB0 may perform a cell search procedure to find an optimal cell, and select a cell through the cell search procedure (S605). When the cell selection is successfully completed, the terminal 610 may receive a master information block (MIB) and a system information block (SIB) from the selected cell (i.e., new target base station). Thereafter, the terminal 610 may perform a random access procedure with the new cell using the received MIB and SIB (S606).

The terminal 610 may transmit an ‘RRCConncectionReestablishmentRequest’ message to the target base station 630 (S607). Then, if the target base station 630 has context information of the terminal 610, the terminal 610 may receive an ‘RRCConncectionReestablishment’ message from the target base station 630 (S608) (or, an ‘RRCConncectionReestablishmentReject’ message when the request of RRC connection re-establishment is rejected by the base station).

Upon receiving the ‘RRCConncectionReestablishment’ message, the terminal 610 may perform a radio resource configuration procedure while performing re-establishment of a PDCP layer and an RLC layer for an SRB1, and resume the SRB1 (S609).

Thereafter, the terminal 610 may configure a lower layer to perform integrity protection and ciphering, and reactivate access stratum (AS) security (S610). Then, the terminal 610 may transmit an ‘RRCConncectionReestabelishmentComplete’ message to the target base station 630 (S611). The terminal 610 may receive an ‘RRCConncectionReconfiguration’ message from the target base station 630 (S612). The terminal may re-establish and resume an SRB2 and a data radio bearer (DRB) (S613).

Meanwhile, in the RRC connection re-establishment procedure of the 3GPP LTE and LTE-A, the data transmission/reception interruption time between the terminal and the base station may be from the time when the T30 timer is started (the time when Qₒᵤₜ occurs) to the time when the DRB is resumed after the RRC connection re-establishment procedure succeeds. Here, the data transmission/reception interruption time may include a time required for the terminal 610 to search for the new target base station. The data transmission/reception interruption time may affect communication quality.

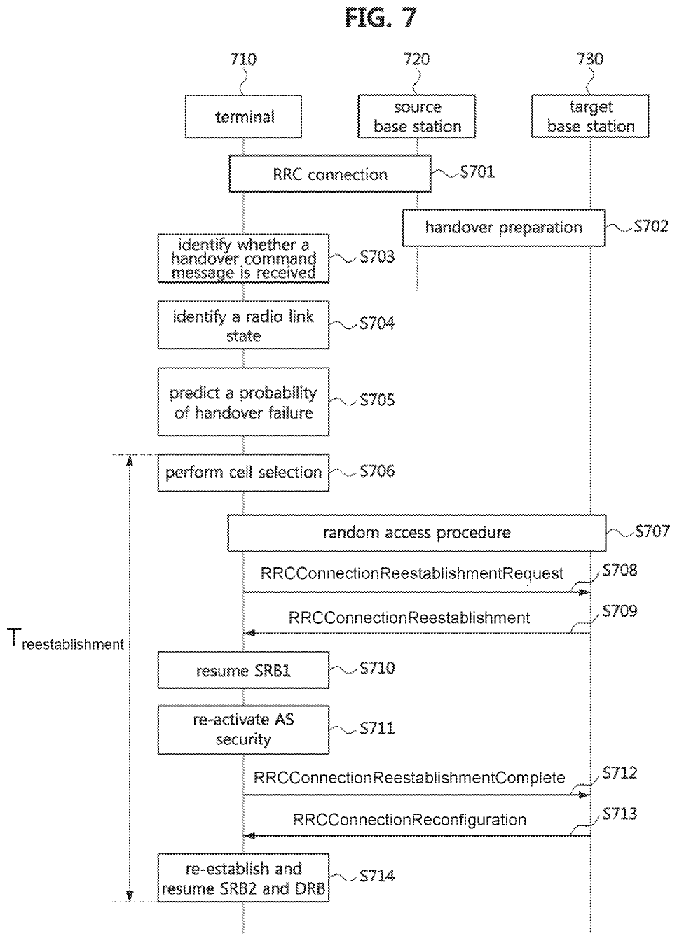

FIG. 7 is a sequence chart illustrating a second exemplary embodiment of an RRC connection reconfiguration procedure in a handover procedure.

Referring to FIG. 7, when a status of a radio link established between a source base station 720 and a terminal 710 is not good, the terminal 710 may not receive a handover command message from the source base station 720, and may continue to maintain a connection with the source base station 720 until an RLF is detected. In this case, in order to overcome this, the terminal 710 may perform an RRC connection re-establishment procedure. The RRC connection re-establishment procedure may be performed in the RRC connected state (i.e., RRC CONNECTED state) (S701).

Meanwhile, the source base station 720 and a target base station 730 may prepare for a handover from the source base station 720 to the target base station 730 (S702). Through the handover preparation, if an RLF occurs while the terminal 710 performs the handover to the target base station 730, an RLF recovery procedure may be performed successfully.

The terminal 710 may transmit a first measurement result according to the first measurement to the source base station 720. In some cases, the process of performing the first measurement and the process of transmitting the first measurement result to the source base station 720 may be omitted. The terminal 710 may perform measurement (i.e., measurement performed after the first measurement) on the source base station 720 and neighbor base stations, and the terminal 710 may identify a state of a radio link established between the terminal 710 and the source base station 720 (S703). The terminal 710 may identify whether the state of the radio link established between the terminal 710 and the source base station 720 is worse (degraded). The terminal 710 may identify the state of the radio link established between the terminal 710 and the source base station 720 through radio link monitoring (RLM).

In an exemplary embodiment, when out-of-sync messages are received consecutively from the physical layer of the terminal 710, the terminal 710 may determine that the state of the radio link has been further deteriorated. Here, the out-of-sync message may be received from the physical layer of the terminal 710, when a signal-to-interference-and-noise ratio (SINR) value of a signal(s) received from the source base station 720 is lower than a specific threshold (i.e., Th_{SINR}).

The terminal 710 may predict a possibility of a handover failure based on the radio link state and the measurement result determined through the step S703 (S704). The terminal 710 may predict that the handover is to fail when it is determined that the radio link status will worsen. In addition, the terminal 710 may predict that the handover is to fail when a reference signal received power (RSRP) value of a signal(s) received from the source base station 720 is lower than a specific threshold (i.e., Th_{RSRP}). In addition, the terminal 710 may predict that the handover is to fail when a reference signals received quality (RSRQ) value of a signal(s) received from the source base station 720 is lower than a specific threshold (i.e., Th_{RSRQ}).

The terminal 710 may identify whether a handover command message is received (S705). When the state of the radio link established between the terminal 710 and the source base station 720 is not good, the handover command message may not be received in real time by the terminal 710.

When the handover command message is not received, the terminal 710 may immediately perform cell selection for radio connection re-establishment before an RLF occurs (S706). The terminal 710 may perform the cell selection to perform the RRC connection re-establishment procedure to a target cell.

Meanwhile, when a specific event is satisfied before occurrence of an RLF, the terminal 710 may perform cell selection and perform an RRC connection re-establishment procedure by using a selected cell as a target cell. Here, the specific event may be various events (e.g., A1/A2/A3/A4/A5/A6, B1/B2, C1/C2, W1/W2/W3, V1/V2, H1/H2 Events, etc.) defined in the RRC specification. For example, the specific event may correspond to a case where an offset 1, which is a specific offset of the A3 event, of the target cell having the best signal strength is better than an offset 1, which is a specific offset of the A3 event, of the source cell.

In addition, the terminal 710 may immediately perform cell selection when a specific event is satisfied without considering the state of the radio link between the terminal 710 and the source base station 720. Then, the terminal 710 may perform the RRC connection re-establishment procedure by using a selected cell as a target cell. Here, the specific event may be various events (e.g., A1/A2/A3/A4/A5/A6, B1/B2, C1/C2, W1/W2/W3, V1/V2, H1/H2 Events, etc.) defined in the RRC specification. For example, the specific event may be a case in which an offset 2, which is a specific offset of the A3 event of the target cell having the best signal strength, is better than an offset 2, which is a specific offset of the A3 event of the source cell.

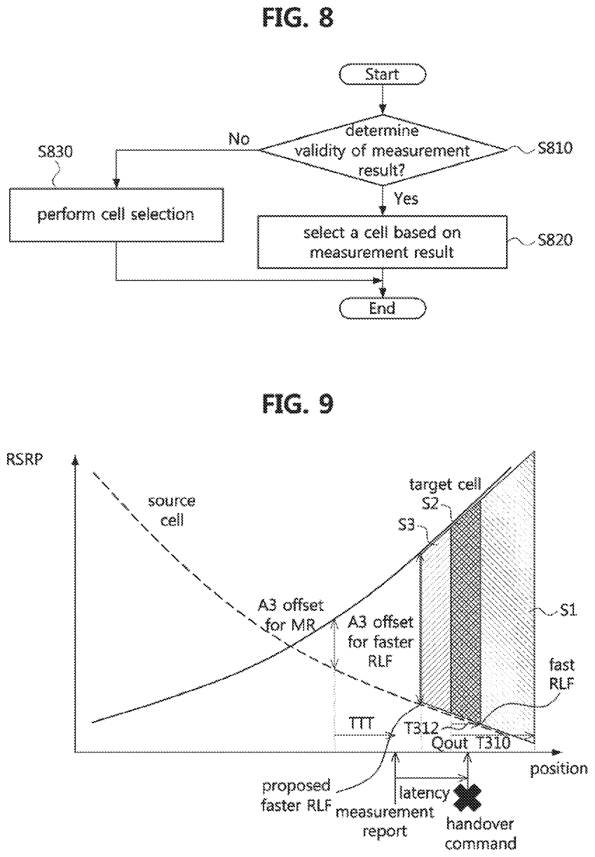

FIG. 8 is a sequence chart illustrating a first exemplary embodiment of a cell selection procedure.

Referring to FIG. 8, a terminal may determine validity of the measurement result for neighbor base stations (S810). Here, the measurement result may be the most recently measured measurement result with reference to a time when the cell selection is performed. As an exemplary embodiment, if a difference between the time when the measurement result is measured and the time when cell selection is performed is smaller than a time value indicated by first valid time information received from the source base station, the measurement result may be determined as valid.

Here, the first valid time information may be ‘connectedMeasResultValidityTime’ received by the terminal from the base station. The ‘connectedMeasResultValidityTime’ may be included in system information transmitted to the entire cell or may be included in an RRC message transmitted from the base station to the terminal. When the ‘connectedMeasResultValidityTime’ is included in both the system information and the RRC message, the ‘connectedMeasResultValidityTime’ included in the RRC message may be applied preferentially. That is, the terminal may determine that the measurement result is valid when the difference between the time of the cell selection for the RRC connection re-establishment procedure and the time when the measurement result is measured is within a value of the ‘connectedMeasResultValidityTime’.

As another exemplary embodiment, the terminal may determine that the measurement result is valid when the time when the measurement result is measured is within a time indicated by second valid time information received from the source base station.

Here, the second valid time information may be a timer value that the base station transmits to the terminal. The timer value may be included in system information transmitted to the entire cell or may be included in an RRC message transmitted by the base station to the terminal. When the second valid time information is included in both the system information and the RRC message, the information included in the RRC message may be applied preferentially. The terminal may start a timer at the time when the measurement result is measured, and may determine that the measurement result is valid when the timer does not expire. Meanwhile, the terminal may autonomously determine whether the measurement result is valid.

When it is determined through the step S810 that the measurement result is valid, the terminal may select a new cell based on the measurement result (S820). As an exemplary embodiment, the terminal may select a new cell based on the measurement result without performing additional measurement for cell selection in the RRC connection re-establishment procedure. For example, the terminal may select a new cell based on an RSRP or RSRQ which is the measurement result. Specifically, the terminal may select a cell with a high RSRP or RSRQ value as a new cell. In this case, since the terminal does not additionally perform measurement for cell selection, the RRC connection re-establishment procedure can be quickly performed, and as a result, the data interruption time can be shortened.

As another exemplary embodiment, the terminal may perform measurement for cell selection in the order of cells having the highest signal strengths, such as the RSRP or RSRQ which is the measurement result. In this case, a cell that satisfies a cell selection criterion ‘S’ may be selected as a new cell.

As another exemplary embodiment, when a difference between a value of the cell selection criterion of the cell selected based on the measurement result and a value of the cell selection criterion of the cell determined at the time of the cell selection is within a range of ‘rangeToBestCellForReestablishment’, the second may select the cell selected based on the measurement result as the target cell for the RRC connection re-establishment procedure.

As another exemplary embodiment, the terminal may select a cell having the highest cell selection criterion value among cells having the cell selection criterion value within the range of ‘rangeToBestCellForReestablishment’ and a cell selected among one or more cells selected based on the measurement result as a target cell for the RRC connection re-establishment. As described above, when the system information for the corresponding cell is valid, the data interruption time may be shortened by the terminal omitting a system information acquisition procedure. Thereafter, the terminal may determine whether the RRC connection re-establishment procedure has been performed through the cell selected based on the measurement result.

Alternatively, when it is determined through the step S810 that the measurement result is not valid, the terminal may perform cell selection based on other measurement result(s) (S830). As an exemplary embodiment, the terminal may perform cell selection through a stored information cell selection procedure by using stored information. For example, when a cell selection parameter, such as a carrier frequency, is a valid value, the terminal may perform cell selection based on this. Thereafter, the terminal may perform an RRC connection re-establishment procedure through a cell selected based on the stored information cell selection procedure. Thereafter, the terminal may determine whether the RRC connection re-establishment procedure has been performed through the cell selected based on the stored information cell selection procedure.

When the cell selection is not performed through the stored information cell selection procedure, the terminal may perform an initial cell selection procedure. When the cell selection is completed and a new cell is determined, the terminal may attempt an RRC connection re-establishment procedure. On the other hand, when it is determined that the RRC connection re-establishment procedure is highly likely to fail, for example, when the selected cell is not ready for handover or a context fetch is not performed, the terminal may not attempt the RRC connection re-establishment procedure again, and may immediately attempt an RRC connection establishment procedure. Referring back to FIG. 7, the processes performed in the steps S707 to S714 may be the same as the processes performed in the steps S606 to S613 of FIG. 6.

FIG. 9 is a graph illustrating a data transmission gain obtained through the second exemplary embodiment of the RRC connection re-establishment procedure of FIG. 7.

Referring to FIG. 9, when the terminal performs the RRC connection re-establishment procedure according to the second exemplary embodiment of FIG. 7, an improved data transmission gain may be obtained. For example, the data transmission gain obtained by performing the cell change based on the consecutive out-of-sync messages that are continuously received by the terminal may be represented as a (S1+S2) region. Meanwhile, the out-of-sync message may be generated when an SINR is lower than the specific threshold Qₒᵤₜ. Here, if a case when the SINR is lower than a specific threshold (i.e., Th_{SINR}) is defined as Qᵣₑₛₑₜ, and the terminal performs the cell change based on Qᵣₑₛₑₜ, a data transmission gain as much as a S3 region may be additionally obtained compared to the existing handover failure recovery method.

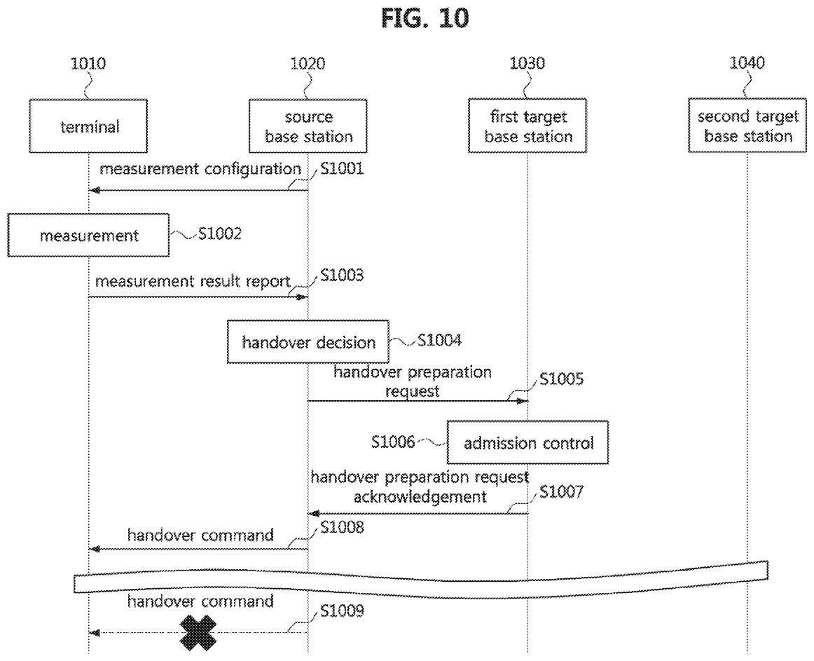

FIG. 10 is a sequence chart illustrating a third exemplary embodiment of a handover procedure.

Referring to FIG. 10, when a terminal 1010 is a terminal 1010 supporting a conditional handover, the terminal 1010 may have already received a handover command message indicating handover to a first target base station 1030 (S1008).

For example, the terminal 1010 may have already received the handover command message for the first target base station 1030. Thereafter, a handover preparation event may occur for a second target base station 1040, and the terminal 1010 may transmit a measurement result to a source base station 1020. In this case, if a state of a radio link between the terminal 1010 and the source base station 1020 is not good, the terminal 1010 may not receive a handover command message for the second target base station 1040 (S1009). Thereafter, the terminal 1010 may predict a possibility of handover failure based on the state of the radio link between the terminal 1010 and the source base station 1020. The above processes may be the same as the steps S703 to S705 described with reference to FIG. 7.

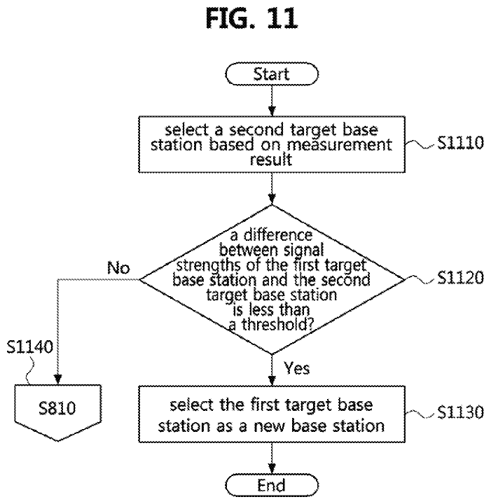

FIG. 11 is a sequence chart illustrating a second exemplary embodiment of a cell selection procedure.

Referring to FIG. 11, when it is predicted that the handover to the second target base station 1040 is to fail, the terminal 1010 may perform cell selection. In this case, the terminal 1010 may have already received a handover command message for the first target base station 1030. The terminal 1010 may determine validity of a second measurement result for neighbor base stations. Here, the second measurement result may be a result measured through second measurement on the neighbor base stations before the time of performing cell selection. When it is determined that the second measurement result is valid, the terminal 1010 may preferentially select the second target base station 1040 selected based on the second measurement result (S1110). The second target base station 1040 may be a base station having the highest signal strength (e.g., SINR, RSRQ, or RSRP).

Thereafter, the terminal 1010 may determine whether a difference between a signal strength of the first target base station 1030 and a signal strength of the second target base station 1040 is less than a predetermined threshold (S1120). When the difference between the signal strength of the first target base station 1030 and the signal strength of the second target base station 1040 is less than the predetermined threshold, the terminal 1010 may select the first target base station 1030 as a new target base station (S1130). Here, the predetermined threshold may be ‘rangeToBestCellForCHOCommand’.

In general, the data interruption time when the handover is successful may be very shorter than the data interruption time when the RLF recovery is successful. Accordingly, when the base station having a high probability of success in handover is selected, the possibility of shortening the data interruption time may increase. Therefore, the terminal 1010 may compare the signal strength of the first target base station 1030 indicated by the handover command message received from the source base station 1020 and the signal strength of the second target base station 1040 selected based on the measurement result, and determine whether the difference between the signal strengths is within a range of ‘rangeToBestCellForCHOCommand’. When the difference between the signal strengths is within the range of ‘rangeToBestCellForCHOCommand’, the terminal 1010 may select the first target base station indicated by the handover command message that has been already received as a new base station instead of the second target base station 1040 selected based on the measurement result. Then, the terminal 1010 may perform handover to the first target base station 1030. When the difference between the signal strengths is not within the range of ‘rangeToBestCellForCHOCommand’, the cell selection may be performed by the method described with reference to FIG. 8 (S1140).

Meanwhile, the processes performed in the steps S606 to S613 described with reference to FIG. 6 and the processes performed in the steps S707 to S714 described with reference to FIG. 7 may be equally applied to the exemplary embodiments described with reference to FIGS. 10 and 11.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method of a terminal in a communication system, the operation method comprising:
performing measurement on a source base station and neighbor base stations, and identifying a state of a radio link established between the terminal and the source base station;
predicting a probability of a handover failure based on the state of the radio link and a measurement result according to the measurement;
when it is predicted that the handover is to fail, identifying whether a handover command message is received from the source base station; and
when the handover command message is not received, performing cell selection for radio connection re-establishment.

2. The operation method according to claim 1, wherein the state of the radio link is identified by the terminal through radio link monitoring (RLM).

3. The operation method according to claim 1, wherein when out-of-sync messages are continuously received from a physical layer of the terminal, the terminal predicts that the handover is to fail.

4. The operation method according to claim 3, wherein the out-of-sync message is received from the physical layer of the terminal, when a value of a signal-to-interference-and-noise ratio (SINR) of a signal received from the source base station is less than a predetermined threshold.

5. The operation method according to claim 1, wherein when a value of one of a reference signal received power (RSRP) and a reference signal received quality (RSRQ) of a signal received from the source base station is less than a predetermined threshold, the terminal predicts that the handover is to fail.

6. The operation method according to claim 1, wherein the performing of the cell selection comprises:
determining validity of the measurement result; and
when the measurement result is determined to be valid, performing the cell selection for the radio connection re-establishment based on the measurement result,
wherein the measurement is performed before performing the cell selection for the radio connection re-establishment.

7. The operation method according to claim 6, wherein the measurement result is determined to be valid, when a difference value between a time of performing the measurement and a time of performing the cell selection for the radio connection re-establishment is less than a time value indicated by valid time information received from the source base station.

8. The operation method according to claim 6, further comprising, when the measurement result is determined to be not valid, performing a cell selection procedure utilizing stored information.

9. The operation method according to claim 8, further comprising, when a cell for the radio connection re-establishment is not selected based on the cell selection procedure utilizing stored information, performing an initial cell selection procedure.

10. The operation method according to claim 1, further comprising performing a radio resource control (RRC) connection re-establishment procedure with a target base station selected through the cell selection.

11. A terminal in a communication system, the terminal comprising:
a processor;
a memory electronically communicating with the processor; and
instructions stored in the memory,
wherein when executed by the processor, the instructions cause the terminal to:
perform measurement on a source base station and neighbor base stations, and identify a state of a radio link established between the terminal and the source base station;
predict a probability of a handover failure based on the state of the radio link and a measurement result according to the measurement;
when it is predicted that the handover is to fail, identify whether a handover command message is received from the source base station; and
when the handover command message is not received, perform cell selection for radio connection re-establishment.

12. The terminal according to claim 11, wherein the state of the radio link is identified by the terminal through radio link monitoring (RLM).

13. The terminal according to claim 11, wherein when out-of-sync messages are continuously received from a physical layer of the terminal, the terminal predicts that the handover is to fail.

14. The terminal according to claim 13, wherein the out-of-sync message is received from the physical layer of the terminal, when a value of a signal-to-interference-and-noise ratio (SINR) of a signal received from the source base station is less than a predetermined threshold.

15. The terminal according to claim 11, wherein when a value of one of a reference signal received power (RSRP) and a reference signal received quality (RSRQ) of a signal received from the source base station is less than a predetermined threshold, the terminal predicts that the handover is to fail.

16. The terminal according to claim 12, wherein the performing of the cell selection comprises:
determining validity of the measurement result; and
when the measurement result is determined to be valid, performing the cell selection for the radio connection re-establishment based on the measurement result,
wherein the measurement is performed before performing the cell selection for the radio connection re-establishment.

17. The terminal according to claim 16, wherein the measurement result is determined to be valid, when a difference value between a time of performing the measurement and a time of performing the cell selection for the radio connection re-establishment is less than a time value indicated by valid time information received from the source base station.

18. The terminal according to claim 16, wherein the instructions further cause the terminal to, when the measurement result is determined to be not valid, perform a cell selection procedure utilizing stored information.
